(19) United States
(12) Patent Application Publication
(10) Pub. No.: US 2008/0239767 A1
(43) Pub. Date: Oct. 2, 2008

(54) Power supply circuit with pulse generating circuit and current-limiting circuit

(75) Inventors: Jie-Jian Zheng, Shenzhen (CN); Tong Zhou, Shenzhen (CN); Jian-Hui Lu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/079,976

(22) Filed: Mar. 31, 2008

(30) Foreign Application Priority Data
Mar. 30, 2007 (CN) 200710073761.X

(51) Int. Cl. H02M 3/335

(52) U.S. Cl. 363/21.16

(57) ABSTRACT

An exemplary power supply circuit (200) includes a transformer (240), a first transistor (260), a start-up resistor (261), and a pulse generating circuit (250). The transformer includes a primary winding (241), a secondary winding (243), and an auxiliary winding (242). The first bipolar junction transistor includes a collector connected to a first terminal of the primary winding and an emitter grounded. The start-up resistor is connected between a second terminal of the primary winding and a base of the bipolar junction transistor. The pulse generating circuit is configured for generating a control signal according to an induction voltage of the auxiliary winding. The control signal is provided to the base of the first bipolar junction transistor for switching the first bipolar junction transistor.

### FIELD OF THE INVENTION

The present invention relates to power supply circuits, and particularly to a power supply circuit with a pulse generating circuit and a current-limiting circuit.

### BACKGROUND

In general, an electronic apparatus such as a liquid crystal display (LCD) device needs to have a power supply circuit installed therein, for converting an external alternating current (AC) voltage into a direct current (DC) voltage.

Referring to FIG. 2, a conventional power supply circuit is shown. The power supply circuit 100 includes a full bridge rectifier circuit 12, a transformer 15, an output circuit 16, an output port 163, a diode 18, a pulse width modulation integrated circuit (PWM IC) 17, a metal oxide semiconductor field effect transistor (MOSFET) 19, and a bias resistor 190. The transformer 15 includes a primary winding 151, a secondary winding 153, and an auxiliary winding 152. The PWM IC 17 includes an input port 171 and a control port 172.

An output (not labeled) of the full bridge rectifier circuit 12 is connected to one terminal of the primary winding 151 of the transformer 150. The other terminal of the primary winding 151 is connected to the MOSFET 19 and the bias resistor 190 in series. The bias resistor 190 is grounded. One terminal of the auxiliary winding 152 of the transformer 150 is connected to the input port 171 of the PWM IC 17 via the diode 18. The other terminal of the auxiliary winding 152 is grounded. A gate of the MOSFET 19 is connected to the control port 172 of the PWM IC 17. The secondary winding 153 is connected to the output port 163 via the output circuit 16.

An external input AC voltage is converted into a DC voltage via the full bridge rectifier circuit 12, and the DC voltage is then provided to the primary winding 151. The auxiliary winding 152 generates an induction voltage, and transmits the induction voltage to the PWM IC 17 via the diode 18 and the input port 171 of the PWM IC 17. The PWM IC 17 outputs a control signal via the control port 172 to switch the MOSFET 19. When the MOSFET 19 is switched on, electric energy is converted into magnetic energy, and the magnetic energy is stored in the primary winding 151. When the MOSFET 19 is switched off, the magnetic energy stored in the primary winding 151 is transferred to the secondary winding 153. Therefore, an AC voltage is generated at the terminal of the secondary winding 153. The induced AC voltage is rectified into a DC voltage via the output circuit 16, and the DC voltage is provided to the output port 163.

The MOSFET 19 is used as a switching element, and is controlled by the PWM IC 17. However, each of the MOSFET 19 and the PWM IC 17 is quite costly, and so the cost of the power supply circuit 100 is correspondingly high. Furthermore, if the external AC voltage surges, the current flowing through the power supply circuit 100 correspondingly increases significantly. Without a protection circuit, the power supply circuit 100 is liable to be burned out. That is, the power supply circuit 100 has rather low reliability.

Accordingly, what is needed is a power supply circuit that can overcome the above-described deficiencies.

### SUMMARY

In a first aspect, a power supply circuit includes a transformer, a bipolar junction transistor, a start-up resistor, and a pulse generating circuit. The transformer includes a primary winding, a secondary winding, and an auxiliary winding. The bipolar junction transistor includes a collector connected to a first terminal of the primary winding and an emitter grounded. The start-up resistor is connected between a second terminal of the primary winding and a base of the bipolar junction transistor. The pulse generating circuit is configured for generating a control signal according to an induction voltage of the auxiliary winding. The control signal is provided to the base of the bipolar junction transistor for switching the bipolar junction transistor.

In a second aspect, a power supply circuit includes a first rectifier circuit, a transformer, a second rectifier circuit, a bipolar junction transistor, and a pulse generating circuit. The transformer includes a primary winding, a secondary winding, and an auxiliary winding. An external alternating current voltage is converted into a direct current voltage by the first rectifier circuit, the transformer, the bipolar junction transistor, and the second rectifier circuit in cooperation. The pulse generating circuit generates control signals according to induction voltages of the auxiliary winding, and outputs the control signals to switch the bipolar junction transistor.

In a third aspect, a power supply circuit includes a transformer, an input circuit, a switching element, a pulse generating circuit, and an output circuit. The transformer includes a primary winding, a secondary winding, and an auxiliary winding. The input circuit converts an external alternating current voltage into a direct current voltage. The direct current voltage is supplied to a first terminal of the primary winding. The switching element is connected between a second terminal of the primary winding and ground. The pulse generating circuit is configured for generating a control signal according to an induction voltage of the auxiliary winding. The control signal is used to control the switching element. The output circuit is connected with the secondary winding for outputting direct current voltage.

Other novel features and advantages will become more apparent from the following detailed description when taken in conjunction with the accompanying drawings.

### BRIEF DESCRIPTION OF THE DRAWINGS

FIG. 1 is a diagram of a power supply circuit according to an exemplary embodiment of the present invention.

FIG. 2 is a diagram of a conventional power supply circuit.

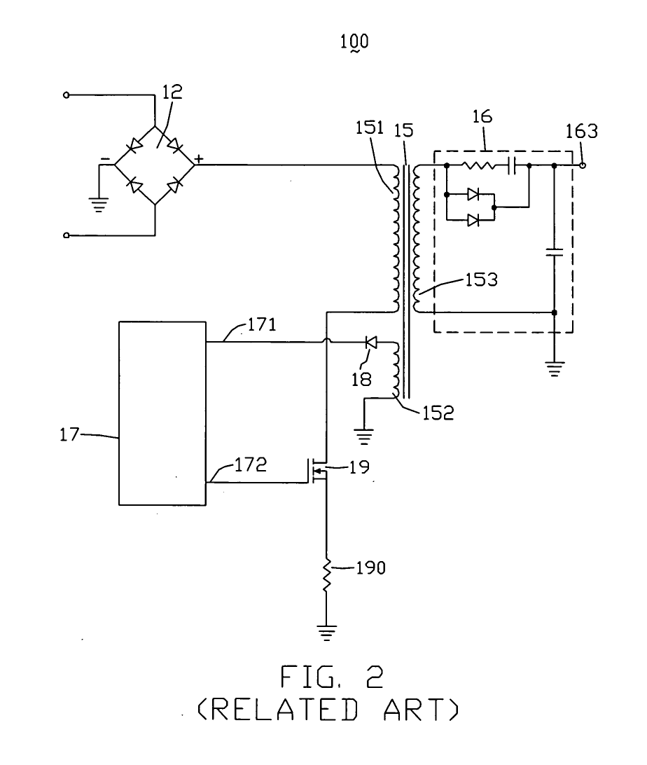

### DETAILED DESCRIPTION OF PREFERRED EMBODIMENTS

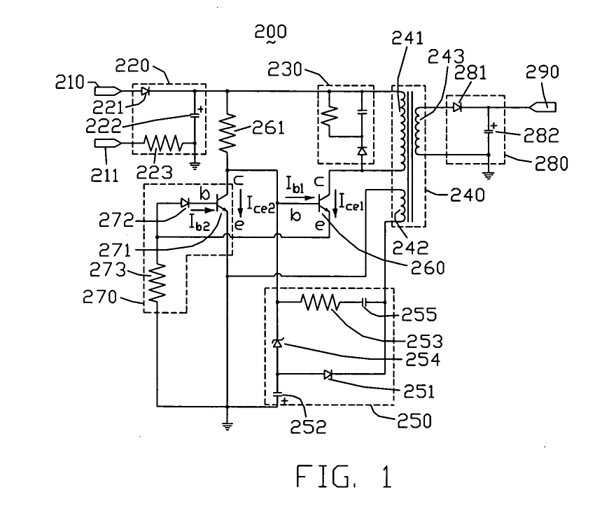

Referring to FIG. 1, this is a diagram of a power supply circuit according to an exemplary embodiment of the present invention. The power supply circuit 200 includes two input ports 210, 211, a rectifier and filter circuit 220, a pulse absorbing circuit 230, a transformer 240, a pulse generating circuit 250, a first transistor 260, a start-up resistor 261, a current-limiting circuit 270, an output circuit 280, and an output port 290.

The rectifier and filter circuit 220 includes a first diode 221, a first capacitor 222, and a first resistor 223. The first capacitor 222 is a polarized capacitor. The transformer 240 includes a primary winding 241, a secondary winding 243, and an auxiliary winding 242. The current-limiting circuit 270 includes a second transistor 271, a second diode 272, and a sampling resistor 273. Each of the first and second transistors 260, 271 is a bipolar junction transistor (BJT), which includes an emitter “e”, a base “b”, and a collector “c”.

The two input ports 210, 211 are also input ports of the rectifier and filter circuit 220. The input port 210 is connected to a positive electrode (not labeled) of the first diode 221. A negative electrode (not labeled) of the first diode 221 is connected to the primary winding 241 of the transformer 240 and the first transistor 260 in series. The collector “c” of the first transistor 260 is connected to the primary winding 241, and the emitter “e” of the first transistor 260 is connected to the sampling resistor 273. The sampling resistor 273 is grounded. A positive electrode (not labeled) of the first capacitor 222 is connected to the negative electrode of the first diode 221. A negative electrode (not labeled) of the first capacitor 222 is grounded. A node between the first diode 221 and the first capacitor 222 is connected to the base “b” of the first transistor 260 via the start-up resistor 261.

The collector “c” of the second transistor 271 is connected to the base “b” of the first transistor 260. The emitter “e” of the second transistor 271 is grounded. The base “b” of the second transistor 271 is grounded via the second diode 272 and the sampling resistor 273 in series.

The pulse absorbing circuit 230 is connected with the primary winding 241 of the transformer 240 in parallel.

The pulse generating circuit 250 includes a third diode 251, a second capacitor 252, a third resistor 253, a voltage stabilizing diode 254, and a third capacitor 255. The second capacitor 252 is a polar capacitor. One terminal of the third resistor 253 is connected to one terminal of the auxiliary winding 242 via the third capacitor 255. The other terminal of the third resistor 253 is connected to the base “b” of the first transistor 260. The other terminal of the auxiliary winding 242 is grounded. A negative electrode of the third diode 251 is connected to a node between the third capacitor 255 and the auxiliary winding 242. A positive electrode of the third diode 251 is grounded via the second capacitor 252. A positive electrode of the second capacitor 252 is connected to ground. The voltage stabilizing diode 254 provides a stable voltage of 6.2 volts. A positive electrode of the voltage stabilizing diode 254 is connected to a negative electrode of the second capacitor 252. A negative electrode of the second capacitor 252 is connected to the base “b” of the first transistor 260.

The output circuit 280 is a rectifier and filter circuit, which is connected between the secondary winding 243 of the transformer 240 and the output port 290. The output circuit 280 includes a fourth diode 281 and a fourth capacitor 282. The fourth capacitor 282 is a polar capacitor. One terminal of the secondary winding 252 is connected to the output port 290 via a positive electrode and a negative electrode of the fourth diode 281 in series. The other terminal of the secondary winding 252 is grounded. The fourth capacitor 282 is connected between the output port 290 and ground, with a positive electrode of the fourth capacitor 282 being connected to the output port 290.

Operation of the power supply circuit 200 is as follows. When an external input AC voltage is applied to the input ports 210, 211, the AC voltage is converted into a DC voltage via the rectifier and filter circuit 220. The first resistor 223 functions as a current-limiting resistor. The DC voltage is supplied to the collector “c” and the base “b” of the first transistor 260 via the primary winding 241 of the transformer 240 and the start-up resistor 261, respectively. Then a base current I_{b1} flowing through the base “b” is generated. The first transistor 260 amplifies the current I_{b1}, thereby forming a collector-emitter current I_{ce1} flowing from the collector “c” to the emitter “e”. Accordingly, the first transistor 260 is switched on. Then the current flows to ground via the sampling resistor 273. Due to an electromagnetic induction effect, electrical energy is converted into magnetic energy, which is stored in the primary winding 241 of the transformer 240. The current increases linearly until the magnetic energy reaches a peak.

When the current flows through the primary winding 241, an induction voltage (induction electromotive force) is generated between the two terminals of the auxiliary winding 242. The induction voltage is applied to a node between the second capacitor 252 and the voltage stabilizing diode 254 via the third diode 251. Along with an increase in the induction voltage, a voltage applied to the voltage stabilizing diode 254 reaches a breakdown voltage, whereupon the voltage stabilizing diode 254 breaks down. Then a voltage of the base “b” of the first transistor 260 is pull down to a low voltage. Accordingly, the base current I_{b1} decreases to zero. That is, the first transistor 260 is switched off.

When the first transistor 260 is switched off, the magnetic energy stored in the primary winding 241 of the transformer 240 is transferred to the secondary winding 243. Therefore, an AC voltage is generated at one terminal of the secondary winding 243. The AC voltage is converted into a steady DC voltage via the output circuit 280, and the steady DC voltage is provided to the output port 290.

Meanwhile, no current flows through the auxiliary winding 242. The auxiliary winding 242 functions as a conductive line. One electrode of the third capacitor 255 is connected to ground via the auxiliary winding 242. The other electrode of the third capacitor 255 is connected to the output of the rectifier and filter circuit 220 sequentially via the third resistor 253 and the start-up resistor 261. The rectifier and filter circuit 220 charges the third capacitor 255 via the start-up resistor 261 and the third resistor 253. Thus, a voltage provided to the base “b” of the first resistor 260 increases gradually until the voltage reaches a start-up voltage, whereupon the first transistor 260 is switched on. Accordingly, a current flows through the primary winding 241 of the transformer 240 again. The above-described process is a working cycle of the power supply circuit 200. The cycle repeats such that a stable voltage is provided to the output port 290.

In operation, an excitation current would ordinarily be generated through the primary winding 241. The excitation current would potentially damage the power supply circuit 200. However, the pulse absorbing circuit 230 works as a protective circuit to consume the excitation current, in order to protect the power supply circuit 200.

When the current flows through the sampling resistor 273, a voltage sampled by the sampling resistor 273 is provided to the base “b” of the second transistor 271 via the second diode 272. In a normal working state of the power supply circuit 200, the sample voltage is limited to a value less than the start-up voltage of the second transistor 271, and the current-limiting circuit 270 is in an “off” state. However, if the power supply circuit 200 is in an abnormal working state, such as an overload or a short circuit, the current flowing through the primary winding 241 and the sampling resistor 273 is over a rated current. The sample voltage of the sampling resistor 273 increases as well. When the sample voltage is higher than the start-up voltage of the second transistor 271, a base current I_{b2} and a corresponding collector-emitter current I_{ce2} are formed. Therefore, the second transistor 271 is switched on. Then a total current flowing through the start-up resistor 261 increases. As a result, a voltage divided by the start-up resistor 261 increases, and a voltage provided to the base “b” of the first transistor 260 decreases. When the voltage provided to the base “b” of the first transistor 260 is lower than the start-up voltage of the first transistor 260, the first transistor 260 is switched off. Accordingly, the power supply circuit 200 is switched off, in order to avoid damage.

Unlike with the above-described conventional power supply circuit 100, the first transistor 260 of the power supply circuit 200 is used as a switch member. Because the first transistor 260 is a BJT, it is inexpensive compared to the MOSFET 19 of the conventional power supply circuit 100. In addition, the pulse generating circuit 250 is also achieved by the auxiliary winding 242 and peripheral electric members such as the third resistor 253 and the third capacitor 255, with no need for the pulse generating IC 17 required in the power supply circuit 100. This configuration also contributes to reducing the cost of the power supply circuit 200. Furthermore, the power supply circuit 200 includes a current-limiting circuit 270 to protect the power supply circuit 200 from an overload or a short circuit. Thus the power supply circuit 200 has high reliability.

It is to be understood, however, that even though numerous characteristics and advantages of the present embodiments have been set out in the foregoing description, together with details of the structures and functions of the embodiments, the disclosure is illustrative only; and changes may be made in detail, especially in matters of arrangement of parts within the principles of the invention to the full extent indicated by the broad general meaning of the terms in which the appended claims are expressed.

What is claimed is:

1. A power supply circuit, comprising:
a transformer comprising a primary winding, a secondary winding, and an auxiliary winding;
a first bipolar junction transistor with a collector, an emitter, and a base, the collector being connected to a first terminal of the primary winding, the emitter being grounded;
a start-up resistor connected between a second terminal of the primary winding and the base of the first bipolar junction transistor; and
a pulse generating circuit configured for generating a control signal according to an induction voltage of the auxiliary winding, the control signal being provided to the base of the first bipolar junction transistor for switching the first bipolar junction transistor.

2. The power supply circuit as claimed in claim 1, wherein the pulse generating circuit comprises a first resistor, a first capacitor, a second capacitor, a first diode, and a voltage stabilizing diode, one terminal of the first capacitor is connected to a first terminal of the auxiliary winding, the other terminal of the first capacitor is connected to the base of the first bipolar junction transistor via the first resistor, a second terminal of the auxiliary winding is grounded, a negative electrode of the voltage stabilizing diode is connected to the base of the first bipolar junction transistor, a positive electrode of the voltage stabilizing diode is grounded via the second capacitor, and the second diode is connected between the positive electrode of the voltage stabilizing diode and the first terminal of the auxiliary winding.

3. The power supply circuit as claimed in claim 1, further comprising a current-limiting circuit configured for sampling a current flowing through the primary winding and outputting a control voltage to switch the first bipolar junction transistor.

4. The power supply circuit as claimed in claim 3, wherein the current-limiting circuit switches off the first bipolar junction transistor when a current flowing through the primary winding is over a predetermined threshold current.

5. The power supply circuit as claimed in claim 3, wherein the current-limiting circuit comprises a second resistor and a second bipolar junction transistor, the emitter of the first bipolar junction transistor being grounded via the second resistor, a collector of the second bipolar junction transistor connected to the base of the first bipolar junction transistor, an emitter of the second bipolar junction transistor being grounded, and a base of the second bipolar junction transistor being grounded via the second resistor.

6. The power supply circuit as claimed in claim 1, further comprising a rectifier circuit configured for converting an alternating current voltage into a direct current voltage and providing the direct current voltage to the second terminal of the primary winding of the transformer.

7. The power supply circuit as claimed in claim 1, further comprising a rectifier circuit and an output port, an output terminal of the secondary winding being connected to the output port via the rectifier circuit.

8. The power supply circuit as claimed in claim 1, further comprising a pulse absorbing circuit connected between the first and second terminals of the primary winding.

9. A power supply circuit, comprising:
a first rectifier circuit;
a transformer comprising a primary winding, a secondary winding, and an auxiliary winding;
a second rectifier circuit;
a first bipolar junction transistor; and
a pulse generating circuit;
wherein the first rectifier circuit, the transformer, the first bipolar junction transistor, and the second rectifier circuit cooperate to convert an external alternating current voltage into a direct current voltage; and
the pulse generating circuit generates control signals according to induction voltages of the auxiliary winding, and outputs the control signals to switch the first bipolar junction transistor.

10. The power supply circuit as claimed in claim 9, further comprising two input ports, wherein the first rectifier circuit comprises a first diode, a first capacitor, and a first resistor, a positive electrode of the first diode is connected to one of the input ports, a negative electrode of the first diode is grounded via the first capacitor, the first resistor is connected between the other input port and ground, and an output of the first rectifier circuit is connected to the primary winding of the transformer.

11. The power supply circuit as claimed in claim 10, further comprising a start-up resistor connected between the output of the first rectifier circuit and a base of the first bipolar junction transistor.

12. The power supply circuit as claimed in claim 11, wherein the pulse generating circuit comprises a second resistor, a second capacitor, a third capacitor, a second diode, and a voltage stabilizing diode, one terminal of the second capacitor is connected to a first terminal of the auxiliary winding, the other terminal of the second capacitor is connected to the base of the first bipolar junction transistor via the second resistor, a second terminal of the auxiliary winding is grounded, a negative electrode of the voltage stabilizing diode is connected to the base of the first bipolar junction transistor, a positive electrode of the voltage stabilizing diode is grounded via the second capacitor, and the third diode is connected between the positive electrode of the voltage stabilizing diode and the first terminal of the auxiliary winding.

13. The power supply circuit as claimed in claim 12, further comprising a current-limiting circuit configured for sampling a current flowing through the primary winding and outputting a control voltage to a base of the first bipolar junction transistor.

14. The power supply circuit as claimed in claim 13, wherein when a current flowing through the primary winding is over a predetermined threshold current, the current-limiting circuit switches off the first bipolar junction transistor.

15. The power supply circuit as claimed in claim 13, wherein the current-limiting circuit comprises a third resistor and a second bipolar junction transistor, the emitter of the first bipolar junction transistor being grounded via the third resistor, a collector of the second bipolar junction transistor connected to the base of the first bipolar junction transistor, an emitter of the second bipolar junction transistor being grounded, and a base of the second bipolar junction transistor being grounded via the third resistor.

16. A power supply circuit, comprising:
a transformer comprising a primary winding, a secondary winding, and an auxiliary winding;
an input circuit converting an external alternating current voltage into a direct current voltage, the direct current voltage being supplied to a first terminal of the primary winding;
a switching element connected between a second terminal of the primary winding and ground;
a pulse generating circuit configured for generating a control signal according to an induction voltage of the auxiliary winding, the control signal being used to control the switching element; and
an output circuit connected with the secondary winding for outputting a direct current voltage.

17. The power supply circuit as claimed in claim 16, wherein the switching element is a bipolar junction transistor with a base, an emitter, and a collector, the base is connected to an output of the input circuit, the emitter is grounded, and the collector is connected to the second terminal of the primary winding.

18. The power supply circuit as claimed in claim 17, wherein the pulse generating circuit comprises a first resistor, a first capacitor, a second capacitor, a first diode, and a voltage stabilizing diode, one terminal of the first capacitor is connected to a first terminal of the auxiliary winding, the other terminal of the first capacitor is connected to the base of the first bipolar junction transistor via the first resistor, a second terminal of the auxiliary winding is grounded, a negative electrode of the voltage stabilizing diode is connected to the base of the first bipolar junction transistor, a positive electrode of the voltage stabilizing diode is grounded via the second capacitor, and the second diode is connected between the positive electrode of the voltage stabilizing diode and the first terminal of the auxiliary winding.
